(19) United States
(12) Patent Application Publication
(10) Pub. No.: US 2018/0126919 A1
(43) Pub. Date: May 10, 2018

(54) VERSATILE CUP AND DEVICE HOLDER

(71) Applicant: FORD GLOBAL TECHNOLOGIES, LLC, Dearborn, MI (US)

(72) Inventors: Annette Lynn Huebner, White Lake, MI (US); Artur Sakarian, Ann Arbor, MI (US); Kristin Ann Hellman, Walled Lake, MI (US); Matthew B. Rutman, Canton, MI (US)

(21) Appl. No.: 15/347,488

(22) Filed: Nov. 9, 2016

(51) Int. Cl. B60R 11/02; B60N 3/10

(52) U.S. Cl. CPC B60R 11/02; B60N 3/105; B60R 2011/0007; B60R 11/0252; B60R 11/0241

(57) ABSTRACT

A cup and device holder includes a housing having a first end wall, a second end wall, a first sidewall, a second sidewall and a bottom wall defining a storage compartment. The holder further includes a first divider connected to the first and second sidewalls of that housing and a second divider connected to the bottom wall.

### TECHNICAL FIELD

This document relates generally to the motor vehicle equipment field and, more particularly, to a cup and device holder providing greater versatility for customization to hold various items and meet any user application or need.

### BACKGROUND

The center console of most motor vehicles in production today incorporates one or more cup holders that are generally shaped to hold a beverage container. People often use the cup holders to house electronic devices such as smart phones or other loose items that they desire to be within easy reach in the center console. Significantly, the cup holder shape is not designed to accommodate these electronic devices or other items. As a consequence those items may move around or even fall out of the cup holder during vehicle operation.

This document relates to a new and improved cup and device holder that is constructed to provide increased versatility for customization to hold various items and not just beverage containers. As such, the new and improved cup and device holder is better adapted to meet any user application or need, thereby increasing user satisfaction with the motor vehicle.

### SUMMARY

In accordance with the purposes and benefits described herein, a cup and device holder is provided. That cup and device holder comprises a housing having a first end wall, a second end wall, a first sidewall, a second sidewall and a bottom wall defining a storage compartment. In addition, the cup and device includes a first divider connected to the first sidewall and the second sidewall and a second divider connected to the bottom wall.

The second divider may include a first free lateral edge spaced from the first sidewall and a second free lateral edge spaced from the second sidewall.

In addition, the cup and device holder may include a third divider connected to the bottom wall. The third divider may include a third free lateral edge spaced from the first sidewall and a fourth free lateral edge spaced from the second sidewall.

Still further, the cup and device holder may include a fourth divider connected to the first sidewall and the second sidewall. The second divider and third divider may be positioned in the storage compartment between the first divider and the fourth divider.

In addition, the bottom wall may include a track. Further, the second divider may include a first connector received and held in the track. In addition, the third divider may include a second connector received and held in the track.

Still further, the cup and device holder may include a first retaining feature on the first sidewall and the second sidewall adjacent the first end. That first retaining feature may be for receiving and holding the first divider.

Similarly, the cup and device holder may include a second retaining feature on the first sidewall and the second sidewall adjacent the second end. That second retaining feature may be provided for receiving and holding the fourth divider.

The first retaining feature may comprise a first set of opposed slots. The second retaining feature may comprise a second set of opposed slots. Still further, the cup and device holder may further include a first chamber between the first divider and the first end wall. In addition, a second chamber may be provided between the first divider and the second divider. A third chamber may be provided between the second divider and the third divider. A fourth chamber may be provided between the third divider and the fourth divider. Still further, a fifth chamber may be provided between the fourth divider and the second end wall.

In accordance with an additional aspect, a first elongated storage channel may be provided extending between (a) the first sidewall and (b) the first free lateral edge of the second divider and the third free lateral edge of the third divider. In addition, a second elongated storage channel may be provided extending between (a) the second sidewall and (b) the second free lateral edge of the second divider and the fourth free lateral edge of the third divider.

The track may include a first channel and a second channel opposed to the first channel. Further, the track may also include a first rail having a first series of notches and a second rail having a second series of notches. The first rail and first series of notches are opposed to the second rail and the second series of notches.

The first connector may include a first lug that is received in the first channel and a second lug that is received in one notch of the first series of notches. The first connector may further include a third lug received in the second channel and a fourth lug received in another notch of the second series of notches.

In the following description, there are shown and described several preferred embodiments of the cup and device holder. As it should be realized, the cup and device holder is capable of other, different embodiments and its several details are capable of modification in various, obvious aspects all without departing from the cup and device holder as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the cup and device holder and together with the description serve to explain certain principles thereof. In the drawing figures:

FIG. 1 is a perspective view of the cup and device holder illustrating the housing with walls defining a storage compartment for receiving and holding first, second, third and fourth dividers.

FIG. 2a is a detailed top plan view illustrating the construction of the housing including the first and second retaining features and the track in the bottom wall of the housing.

FIGS. 2b-2d illustrate how the second divider is moved along the track from the first position illustrated in FIG. 2a to the second position illustrated in FIG. 2d.

FIG. 3 is a cross-sectional view showing how the lugs on the first divider are received in the notches and channels of the track.

FIGS. 4a-4d are respective cross-sectional views along lines 3̅a̅3̅a̅, 3̅b̅3̅b̅, 3̅c̅3̅c̅ and 3̅d̅3̅d̅ of FIGS. 2a-2d.

FIGS. 5a-5c are perspective views illustrating three possible configurations of the cup and device holder illustrated in FIG. 1 holding various and differing items.

Reference will now be made in detail to the present preferred embodiments of the cup and device holder, examples of which are illustrated in the accompanying drawing figures.

### DETAILED DESCRIPTION

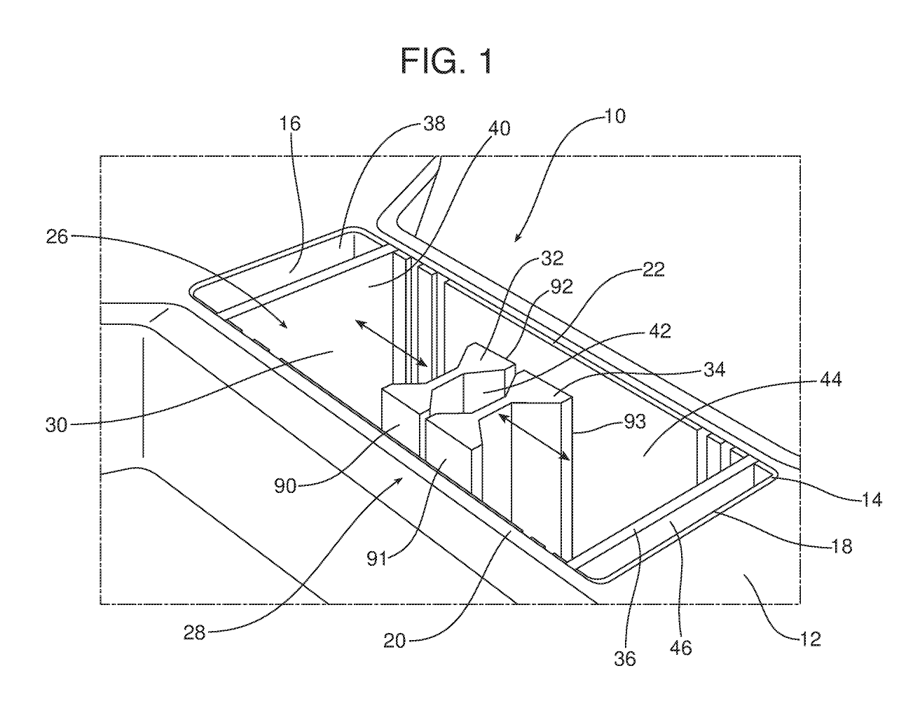

Reference is now made to FIG. 1 illustrating the cup and device holder 10 provided in the center console 12 of a motor vehicle.

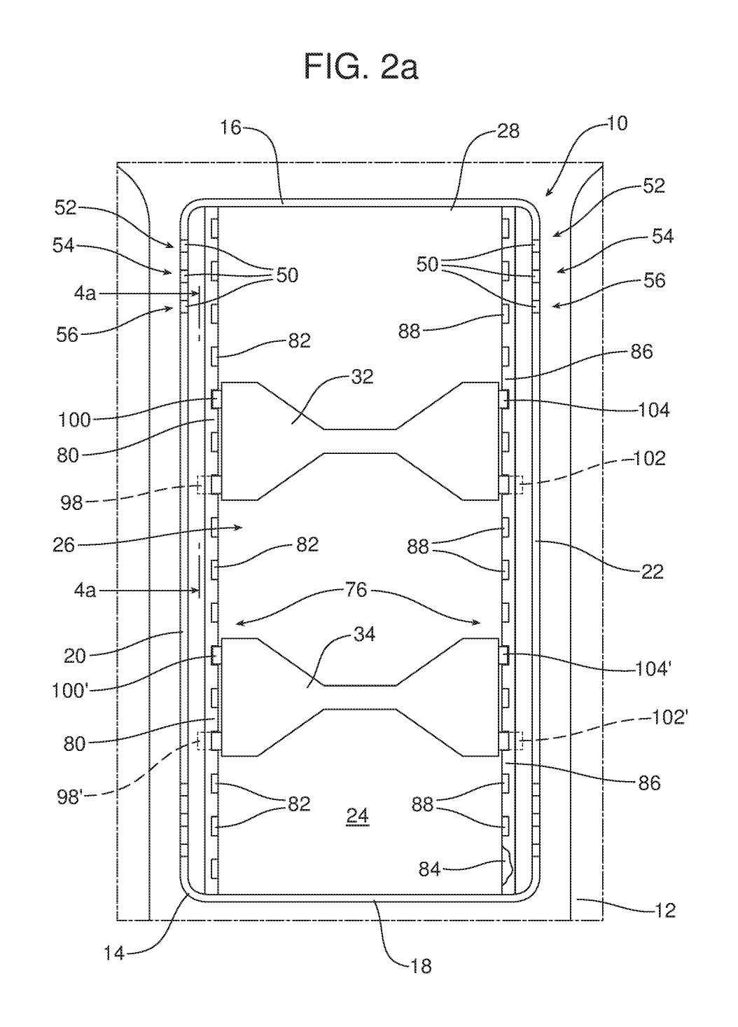

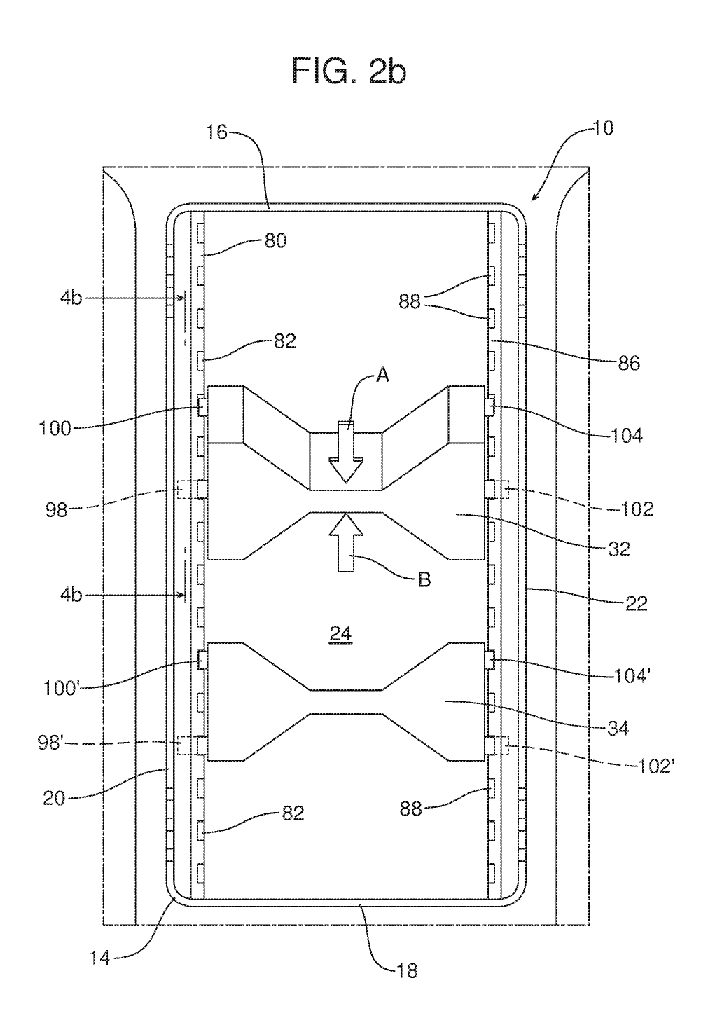

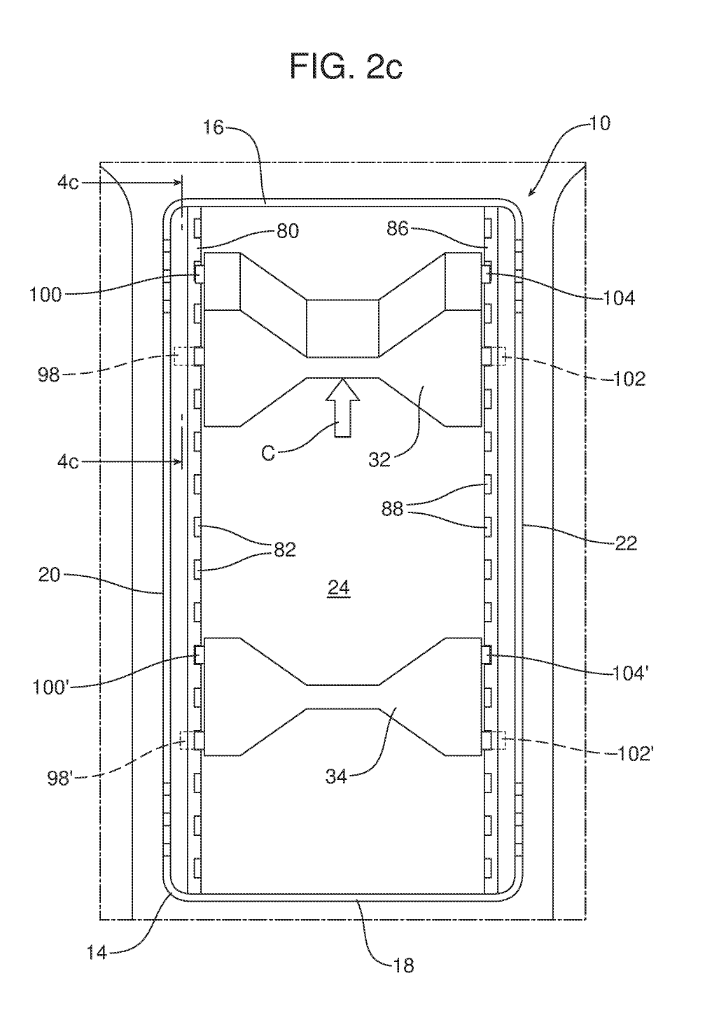

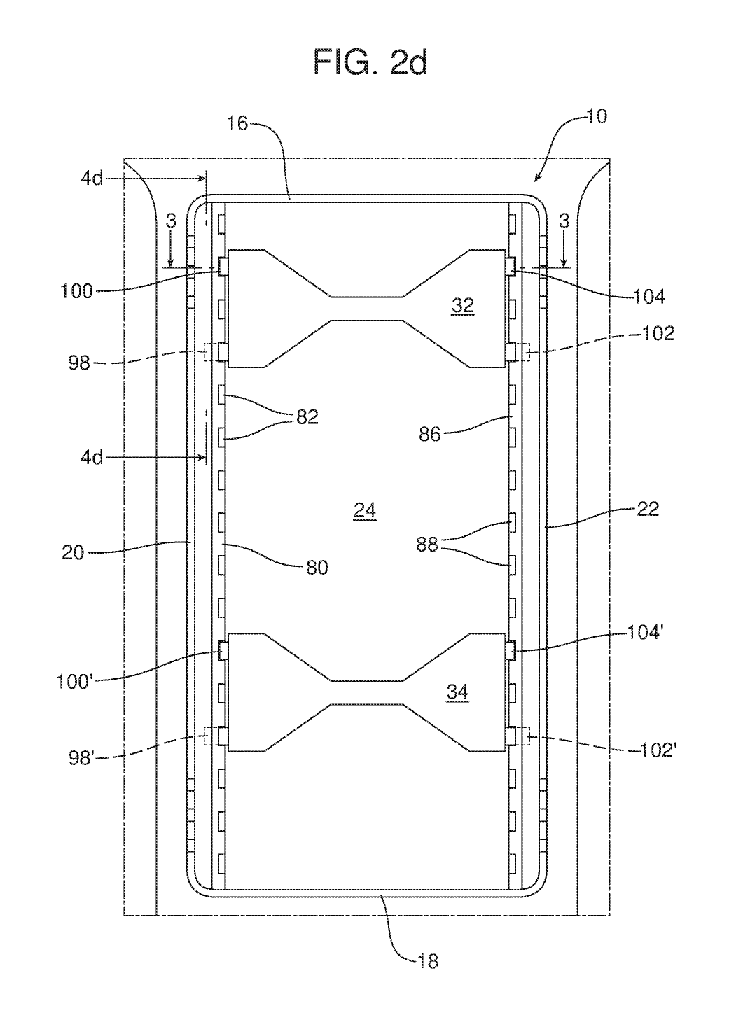

As illustrated in FIGS. 1 and 2a, the cup and device holder 10 includes a housing 14 having a first end wall 16, a second end wall 18, first sidewall 20, a second sidewall 22 and a bottom wall 24. Together the first end wall 16, second end wall 18, first sidewall 20, second sidewall 22 and bottom wall 24 define a storage compartment, generally designated by reference numeral 26, having an open top 28.

In the illustrated embodiment, the cup and device holder 10 also includes a first divider 30, a second divider 32, a third divider 34 and a fourth divider 36. As should be appreciated, the first divider 30, second divider 32, third divider 34, and fourth divider 36 partition the storage compartment 26 into multiple chambers.

More specifically, a first chamber 38 is provided between the first divider 30 and the first end wall 16. A second chamber 40 is provided between the first divider 30 and the second divider 32. A third chamber 42 is provided between the second divider 32 and the third divider 34. A fourth chamber 44 is provided between the third divider 34 and the fourth divider 36. A fifth chamber 46 is provided between the fourth divider 36 and the second end wall 18.

A first retaining feature 48 is provided on the first sidewall 20 and second sidewall 22 adjacent the first end wall 16. In the illustrated embodiment the first retaining feature comprises a series of three channels 50 on each of the first sidewall 20 and second sidewall 22. The channels 50 form a first set of opposing slots 52, a second set of opposing slots 54 and a third set of opposing slots 56.

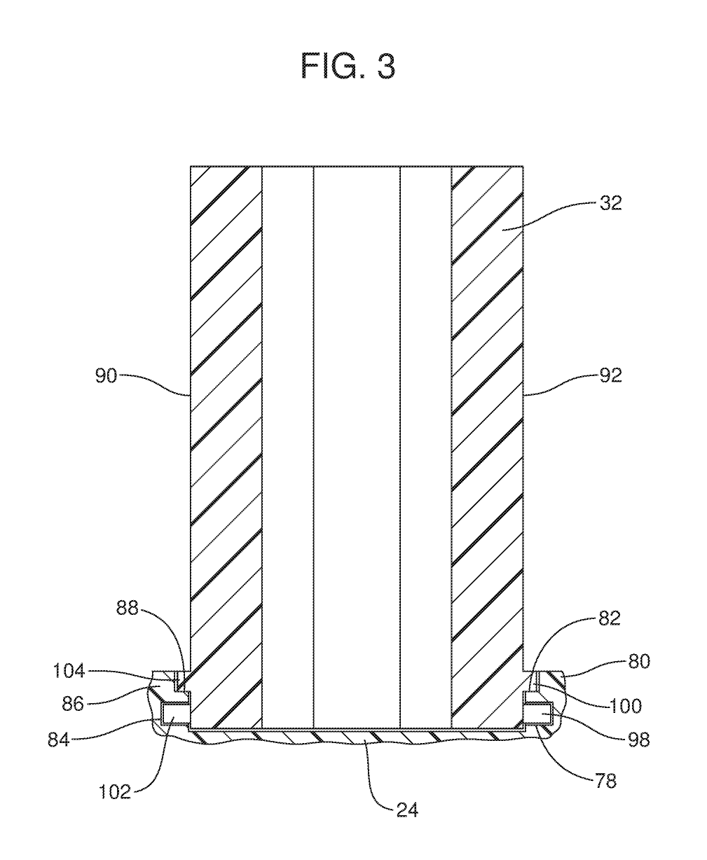

As illustrated in FIG. 3, the first divider 30 includes a first side edge 62 and a second side edge 64. The first divider 30 is sized and shaped to span across the width of the storage compartment 26. Accordingly, the first divider 30 may be secured in a first position by inserting the first side edge 62 and the second side edge 64 in the first set of opposed slots 52 (see FIG. 1). Alternatively, the first divider 30 may be placed in a second position by inserting the first side edge 62 and second side edge 64 in the second set of opposed slots 54. Alternatively, the first divider 30 may be placed in a third position by inserting the first side edge 62 and the second side edge 64 in the third set of slots 56. Here it should be appreciated that when the first divider 30 is placed in the second position, the width of the first chamber 38 is increased compared to the first position. Similarly, when the first divider 30 is placed in the third position, the width of the first chamber 38 is increased further. Thus, it should be appreciated that the size of the first chamber 38 may be customized by the user to meet the needs of a particular application.

Referring back to FIG. 2, the cup and device holder 10 also includes a second retaining feature 66. In the illustrated embodiment, the second retaining feature 66 comprises three channels 68 provided on each of the first sidewall 20 and the second sidewall 22. The channels 68 define a fourth set of opposed slots 70, a fifth set of opposed slots 72 and a sixth set of opposed slots 74.

The fourth divider 36 may be identical in structure to the first divider 30. A user may position the fourth divider 36 in any of three possible positions. The first of those three positions requires the user to insert the fourth divider 36 into the fourth set of opposed slots 70. The second of those three positions requires the user to insert the fourth divider 36 into the fifth set of opposed slots 72. The third of those three positions requires the user to insert the fourth divider 36 into the sixth set of opposed slots 74. As should be appreciated, depending upon the selected position of the fourth divider 36, the width dimension of the fifth chamber 46 may be altered or adjusted thereby allowing customization of that chamber to meet the particular application of the user at any given time.

Referring to FIGS. 2a, 3 and 4a, a track 76 is provided on the bottom wall 24 of the housing 14. In the illustrated embodiment, the track 76 comprises a first channel 78 and a first rail 80 extending along the first sidewall 20 from the first end wall 16 to the second end wall 18. A first series of notches 82 are provided along the top face of the first rail 80.

The track 76 also comprises a second channel 84 and a second rail 86 extending along the second sidewall 22 from the first end wall 16 to the second end wall 18. Note the second rail 86 broken away at the bottom right in FIG. 2a to show the channel 84 that is opposed to the first channel 78. A second series of notches 88 are provided along the top face of the second rail 86.

Reference is now made to FIG. 3 illustrating how the second divider 32 is received and held in the track 76. The divider 32 includes a first free lateral edge 90 and a second free lateral edge 92. A first connector 94 is provided at the bottom of the first free lateral edge 90 and the second free lateral edge 92. The first connector 94 includes a first lug 98, a second lug 100, a third lug 102 and a fourth lug 104.

As best illustrated in FIGS. 2a, 3 and 4a, the second divider 32 is held in a selected position along the track 76 by engagement of the opposed first and third lugs 98, 102 in the opposed channels 78, 84 and engagement of the opposed second and fourth lugs 100, 104 in selected opposed notches of the first and second series of notches 82, 88.

As illustrated in FIGS. 2b and 3b, when one wishes to displace the second divider 32 along the track 76, one applies pressure as indicated by action arrow A, tilting the divider about the opposed first and third lugs 98, 102 so that the second and fourth lugs 100, 104 pivot out of the opposed notches of the first and second series of notches 82, 88.

While maintaining the second divider 32 in this tilted position with the second and fourth lugs 100, 104 free of the first and second series of notches 82, 88, one slides (note action arrow B) the second divider along the track 76 with the first and third lugs 98, 102 sliding freely through the opposed channels 78, 84.

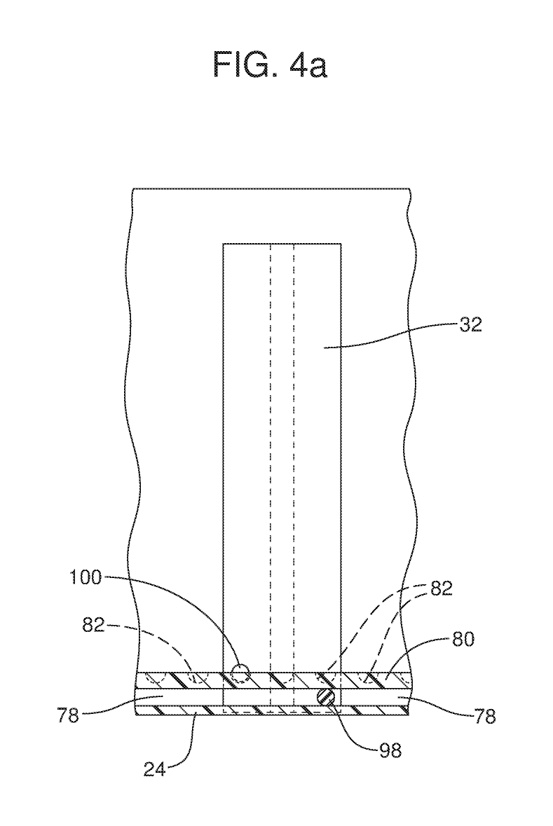

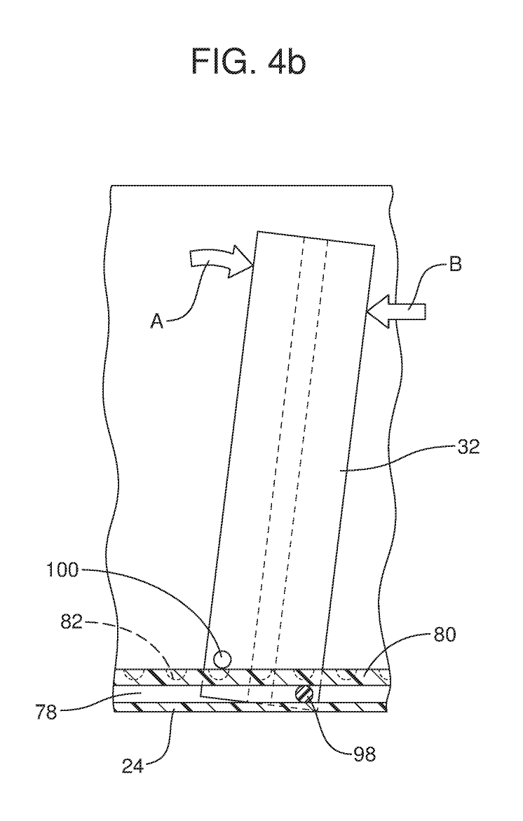

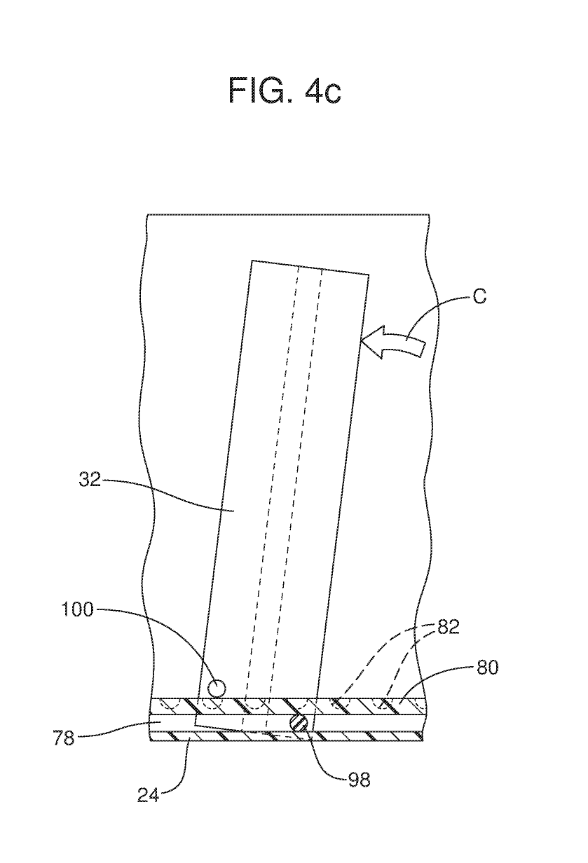

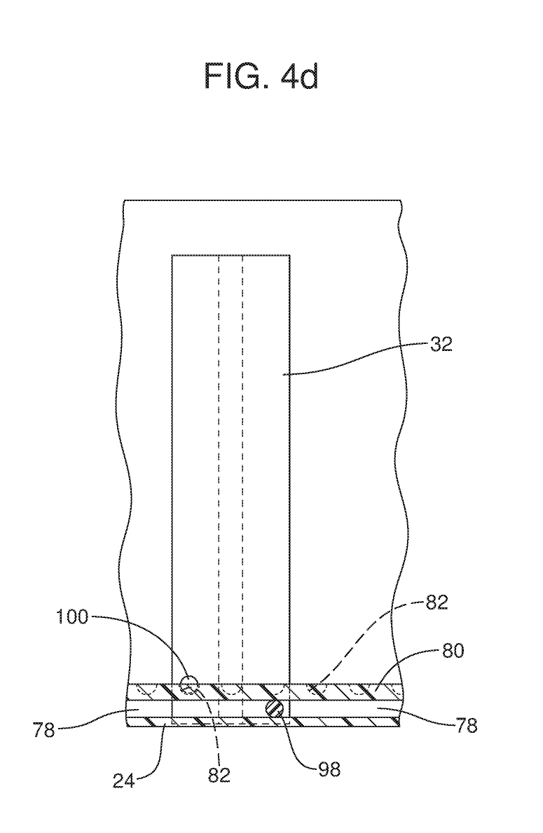

Upon the second divider 32 reaching the desire position, one tilts the second divider 32 back into a vertical position (note action arrow C in FIGS. 3c and 4c). This pivots the second and fourth lugs 100, 104 back into engagement with a new set of opposed notches of the first and second series of notches 82, 88 which function to hold the second divider 32 in the newly selected position along the track 76. Note FIGS. 3d and 4d.

The third divider 34 includes a structure identical to the second divider 32. Note the second connector 96 including the lugs 98′, 100′, extending from the third free lateral edge 91 and the lugs 102′ and 104′ extending from the fourth free lateral edge 93 in FIGS. 2a-2d and 3. As such, the position of the third divider 34 along the track 76 may be adjusted in the same manner.

In the illustrated embodiment, the second divider 32 and the third divider 34 are provided between the first divider 30 and the fourth divider 36 in the storage compartment 26. Accordingly, selected movement or displacement of the second divider 32 and the third divider 34 along the track 76 allows one to customize the size of the second chamber 40 provided between the first divider 30 and the second divider 32, the third chamber 42 provided between the second divider 32 and the third divider 34 and the fourth chamber 44 provided between the third divider 34 and the fourth divider 36.

As should be apparent from reviewing FIGS. 1, 2a, 3 and 5c, the cup and device holder 10 is further distinguished by including a first elongated storage channel 106 extending between (a) the first sidewall 20 and (b) the first free lateral edge 90 of the second divider 32 and the third free lateral edge 108 of the third divider 34.

Similarly, a second elongated storage channel 110 extends between (a) the second sidewall 22 and (b) the second free lateral edge 92 of the second divider 32 and the fourth free lateral edge 112 of the third divider 34. Here it should be appreciated that the first elongated storage channel 106 and the second elongated storage channel 110 are sized and shaped to hold items that could not otherwise be held in the storage compartment 26 by the first chamber 38, second chamber 40, third chamber 42, fourth chamber 44 and fifth chamber 46.

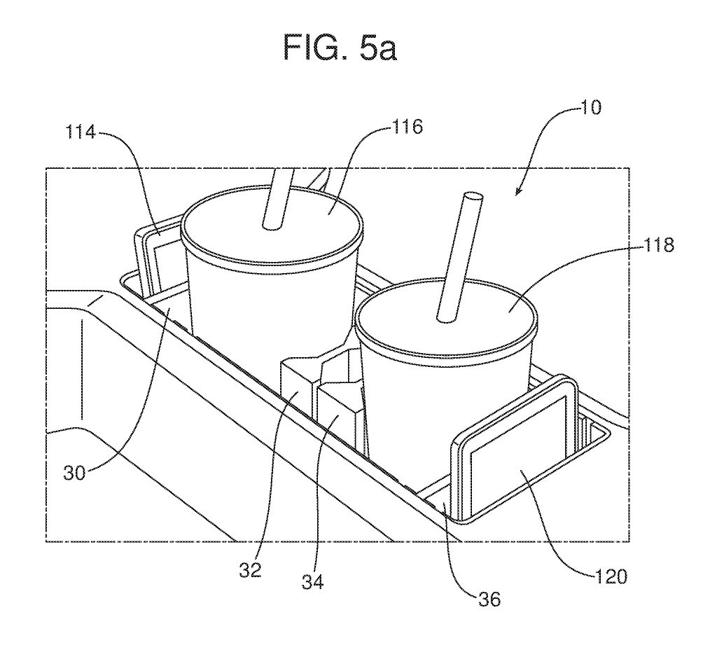

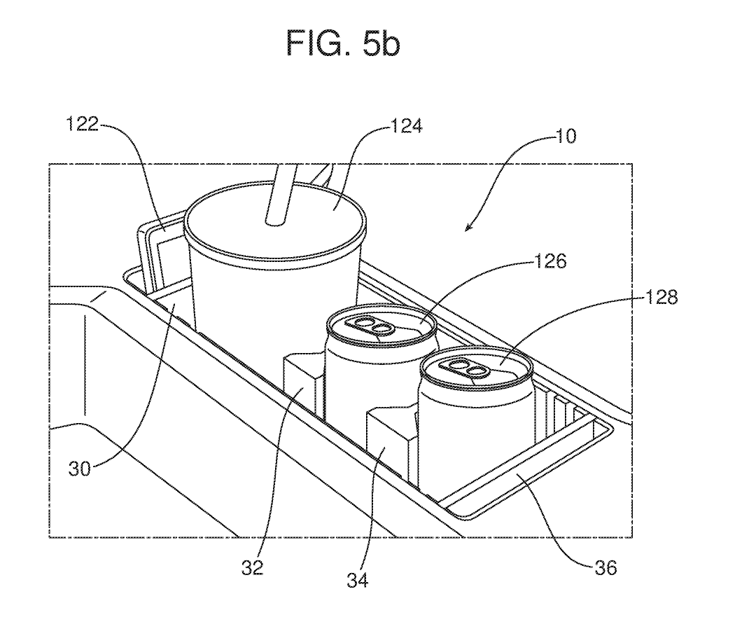

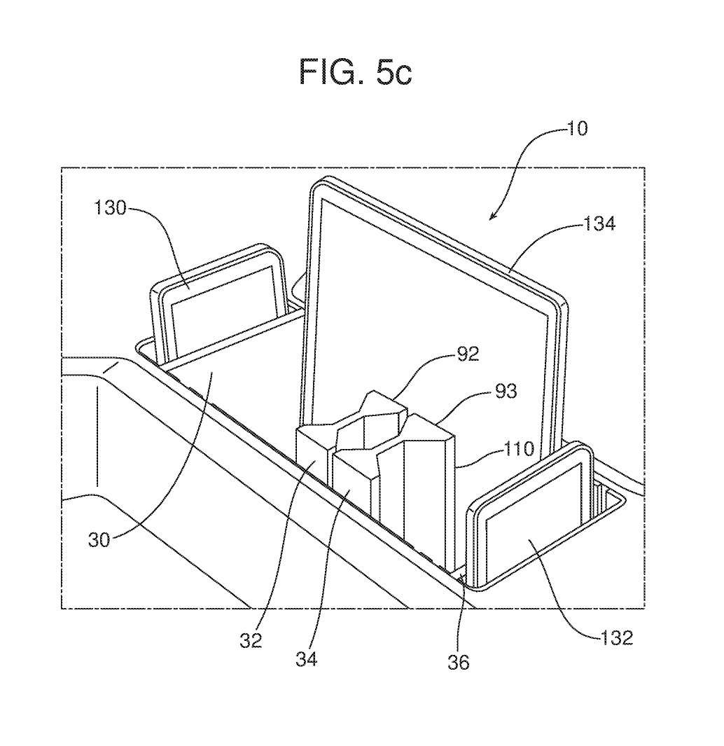

Reference is now made to FIGS. 5a-5c illustrating various configurations of the cup and device holder 10. As illustrated in FIG. 5a, the first divider 30, second divider 32, third divider 34 and fourth divider 36 have been positioned in the storage compartment 26 so that the cup and device holder 10 will hold a first cell phone 114 between the first divider 30 and the first end wall 16, a first oversized fountain drink cup 116 between the first divider 30 and the second divider 32, a second oversized fountain drink cup 118 between the third divider 34 and the fourth divider 36 and a second cell phone 120 between the fourth divider 36 and the second end wall 18.

As illustrated in FIG. 5b, the first divider 30, second divider 32, third divider 34 and fourth divider 36 have been positioned to receive and hold a cell phone 122 between the first divider 30 and the first end wall 16, an oversized drink cup 124 between the first divider 30 and the second divider 32, a first drink can 126 between the second divider 32 and the third divider 34 and a second drink can 128 between the third divider 34 and the fourth divider 36.

As illustrated in FIG. 5c, the first divider 30, second divider 32, third divider 34 and fourth divider 36 have been positioned to hold a first cell phone 130 between the first divider 30 and the first end wall 16 and a second cell phone 132 between the fourth divider 36 and the second end wall 18. A tablet 134 is held in the second elongated storage channel 110 between (a) second sidewall 22 and (b) the second free lateral edge 92 of the second divider 32 and the fourth free lateral edge 93 of the third divider. FIG. 5c illustrates the usefulness of the first elongated storage channel 106 and second elongated storage channel 110 that add to the versatility and customization possibilities of the cup and device holder 10.

The foregoing has been presented for purposes of illustration and description. It is not intended to be exhaustive or to limit the embodiments to the precise form disclosed. Obvious modifications and variations are possible in light of the above teachings. For example, the illustrated embodiment of the cup and device holder 10 includes the first divider 30 and fourth divider 36 of a first type connected between the first sidewall 20 and second sidewall 22 and the second divider 32 and third divider 34 of a second type connected to the bottom wall 24 at the track 76. Fewer or more of either of these types of dividers 30, 32, 34, 36 may be provided in the storage compartment 26 depending on the needs of the user. All such modifications and variations are within the scope of the appended claims when interpreted in accordance with the breadth to which they are fairly, legally and equitably entitled.

1. A cup and device holder, comprising:
a housing having a first end wall, a second end wall, a first sidewall, a second sidewall and a bottom wall defining a storage compartment;
a first divider connected to said first sidewall and said second sidewall; and
a second divider and a third divider, each connected to said bottom wall; and
a fourth divider connected to said first sidewall and said second sidewall.

2. The cup and device holder of claim 1, wherein said second divider includes a first free lateral edge spaced from said first sidewall and a second free lateral edge spaced from said second sidewall.

3. (canceled)

4. The cup and device holder of claim 2, wherein said third divider includes a third free lateral edge spaced from said first sidewall and a fourth free lateral edge spaced from said second sidewall.

5. (canceled)

6. The cup and device holder of claim 4, wherein said second divider and said third divider are positioned in said storage compartment between said first divider and said fourth divider.

7. The cup and device holder of claim 6, wherein said bottom wall includes a track, said second divider includes a first connector received and held in said track and said third divider includes a second connector received and held in said track.

8. The cup and device holder of claim 7, further including a first retaining feature on said first sidewall and said second sidewall adjacent said first end wall, said first retaining feature receiving said first divider.

9. The cup and device holder of claim 8, further including a second retaining feature on said first sidewall and said second sidewall adjacent said second end wall, said second retaining feature receiving said fourth divider.

10. The cup and device holder of claim 9, wherein said first retaining feature comprises a first set of opposed slots and said second retaining feature comprises a second set of opposed slots.

11. The cup and device holder of claim 10, further including a first chamber between said first divider and said first end wall.

12. The cup and device holder of claim 11, further including a second chamber between said first divider and said second divider.

13. The cup and device holder of claim 12, further including a third chamber between said second divider and said third divider.

14. The cup and device holder of claim 13, further including a fourth chamber between said third divider and said fourth divider.

15. The cup and device holder of claim 14, further including a fifth chamber between said fourth divider and said second end wall.

16. The cup and device holder of claim 15, further including a first elongated storage channel extending between (a) said first sidewall and (b) said first free lateral edge and said third free lateral edge.

17. The cup and device holder of claim 16, further including a second elongated storage channel extending between (a) said second sidewall and (b) said second free lateral edge and said fourth free lateral edge.

18. The cup and device holder of claim 17, wherein said track includes a third channel and a fourth channel opposed to said third channel.

19. The cup and device holder of claim 18, wherein said track further includes a first rail having a first series of notches and a second rail having a second series of notches wherein said first rail is opposed to said second rail.

20. The cup and device holder of claim 19, wherein said first connector includes a first lug received in said third channel, a second lug received in one notch of said first series of notches, a third lug received in said fourth channel and a fourth lug received in another notch of said second series of notches.
